(19) United States
(12) Patent Application Publication
(10) Pub. No.: US 2021/0390878 A1
(43) Pub. Date: Dec. 16, 2021

(54) SYSTEMS AND METHODS FOR CAREER SELECTION AND ADAPTIVE LEARNING TECHNIQUES IN THE FIELD OF CYBERSECURITY

(71) Applicant: By Light Professional IT Services LLC, McLean, VA (US)

(72) Inventors: Laura A.T. Lee, San Diego, CA (US); Michelle R. Gabele, Holly Springs, NC (US); Raymond C. Prouty, Escondido, CA (US); Bradley M. Wolfenden, Boulder, CO (US)

(73) Assignee: By Light Professional IT Services LLC, McLean, VA (US)

(21) Appl. No.: 17/343,485

(22) Filed: Jun. 9, 2021

Related U.S. Application Data
(60) Provisional application No. 63/037,869, filed on Jun. 11, 2020.

(51) Int. Cl. G09B 19/00; G09B 7/02; G06N 5/02; G06Q 50/20

(52) U.S. Cl. CPC G09B 19/0053; G06Q 50/2057; G06N 5/022; G09B 7/02

(57) ABSTRACT

A system for identifying a career suitable for a user in cybersecurity and providing an adaptive learning environment to the user's learning styles, has an input device and an output device. Further, the system for identifying a career suitable for a user in cybersecurity and providing an adaptive learning environment to the user's learning styles has a processor that administers a personality test to the user by displaying questions on the output device and receiving responses to the questions from the user on the input device. Further, the processor analyzes the responses and assigns a suitable job/work role fit for the user in cybersecurity and the processor determines the user's learning style based upon the responses. Additionally, the processor teaches and/or trains the user for the suitable job/work role based upon the user's responses and the user's learning style.

### CROSS REFERENCE TO RELATED APPLICATION

This application claims priority to U.S. Provisional Patent Application Ser. No. 63/037,869 entitled Systems and Methods for Identifying Individuals for a Career in the Field of Cybersecurity and for Applying Adaptive Learning Techniques to Train the Individual in the Field of Cybersecurity and filed on Jun. 11, 2020, which is incorporated herein by reference.

### BACKGROUND

Individuals who have a career in cybersecurity implement technologies, processes, and. practices that are designed to protect computer systems, including protecting networks, network devices, and data in the computer system from access by unauthorized individuals or from criminal use. Further, individuals who have a career in cybersecurity ensure confidentiality, integrity, and availability of information by computer systems.

in the present day, most activities for, work, tasks and/or entertainment, rely on computers and the Internet. For example, most people use email, smartphones, tablets, interactive video games, social media, apps, navigation systems, online shopping, provision online of credit card information, medical equipment, and medical records. This is not an exhaustive list.

Systems used in the present day are at risk of unauthorized misuse or criminal use. Cyber risks include malware erasing your entire system, an attacker breaking into your system and altering files, an attacker using your computer to attack others, or an attacker stealing your credit card information and making unauthorized purchases. While these activities are possible, career cybersecurity individuals can take measures to reduce the likelihood that systems are attacked, and these measures may be implemented by the individuals who are well-versed and trained in the art of cybersecurity. Becoming well-versed in cybersecurity takes intense training and is not suited for every individual.

### DESCRIPTION OF THE DRAWINGS

The disclosure can be better understood referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram of a cybersecurity system for career selection and adaptive learning in accordance with an embodiment of the present disclosure.

FIG. 2 is a block diagram of a cyber aptitude typology indicator (CATI) course computing device communicatively coupled to a learning management system as is shown in FIG. 1.

FIG. 3 is an exemplary graphical user interface (GUI) displayed by the CATI course computing device as is shown in FIG. 1 after a user takes a personality test.

FIG. 4 is a chart depicting the National Institute of Standards Cybersecurity Framework (NIST CSF).

FIG. 5 is a chart that represents a combination of the NIST CSF and the National Security Agency (NSA) Center for Academic Excellence—Cyber Defense Education knowledge units having four cyber sub-disciplines as technical areas of concentration to develop the cybersecurity selection method.

FIG. 6 is a block diagram of a CATI computing device such as is shown in FIG. 1.

FIG. 7 is a block diagram of a learning management system (LMS) computing device such as is shown in FIG. 1.

FIG. 8 is a flowchart of the architecture and functionality of the cybersecurity system for career selection and adaptive learning.

### DETAILED DESCRIPTION

The present disclosure is a system that identifies whether an individual is suitable for a cybersecurity career based upon a personality test. Moreover, the system provides an environment where the user may determine where in the cybersecurity field the user may be most effective. Also, the present disclosure describes a system that provides training to users who have been identified as suitable for a career in cybersecurity based on learning styles gleaned from the personality test. The specific training provided to the user is tailored to suit the user based upon a personality test administered before training and teaching begins and based upon input from the user during teaching and training. Thus, the system is an adaptive learning system.

Note that given the large numbers of users in the field of cybersecurity, with specific knowledge, skills, and abilities to specialize in it, the system of the present disclosure customizes training in topics related to each job/work roles. Further, to reduce overall training time to achieve and retain a specific level of expertise in the set of topics for each work role, learning environments are provided to teach the skills tailored to a specific user and their learning style deduced from a personality test and an association of a sub-discipline with specific cybersecurity functions, based upon the personality test and the selection of sub-disciplines suited to the information gleaned from the personality test.

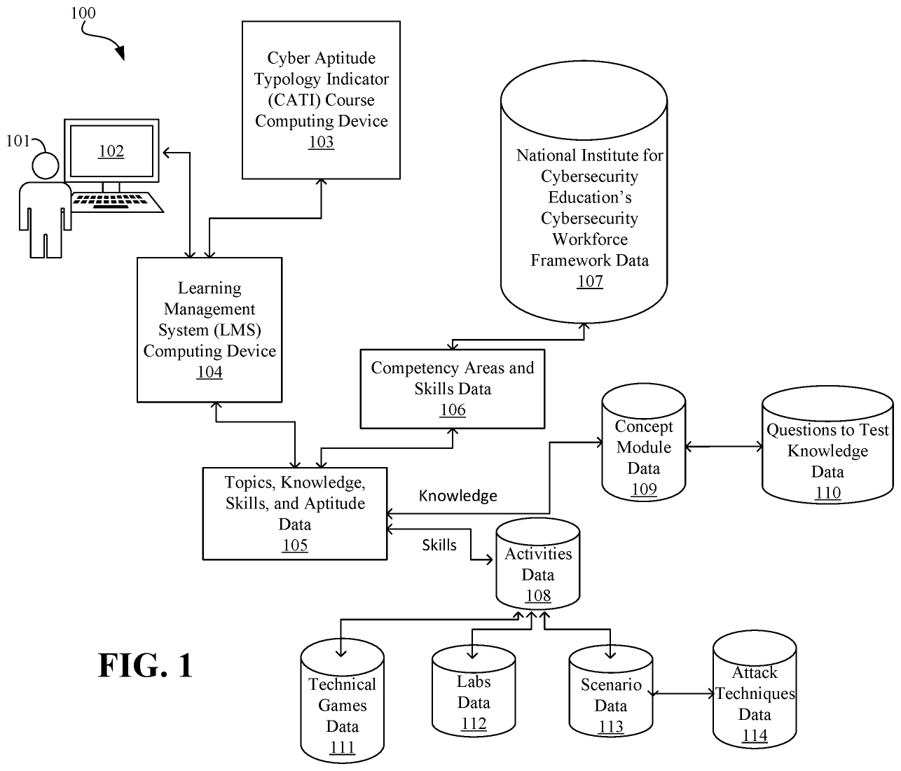

FIG. 1 depicts a cybersecurity system for career selection and adaptive learning 100 of the present disclosure. The cybersecurity system for career selection and adaptive learning 100 comprises a cyber aptitude typology Indicator (CATI) course computing device 103. In addition, the cybersecurity system for career selection and adaptive learning 100 comprises a learning management system (LMS) computing device 104 that is communicatively coupled to the CATI test computing device 103, for example via a direct connection or over a local area network (LAN) (not shown). A user 101 using terminal 102 may access the CATI course computing device 103 and the LMS computing device 104.

The cybersecurity system for career selection and adaptive learning 100 further comprises a plurality of data sources. In this regard, the LMS computing device 104 has access to topics, knowledge, skills, and aptitude data 105, competency areas and skills data 106, and National Institute for Cybersecurity Education Cybersecurity Workforce framework data 107.

Additionally, the cybersecurity system for career selection and adaptive learning 100 further comprises a plurality of databases used in user knowledge training and activity training for a specific cybersecurity job/work role identified. Note that the specific job/work role is identified by a personality test and a CATI algorithm executed by the CATI course computing device 103.

These databases include concept modules database 109, questions to test knowledge 110, activities 108, technical games database 111, labs database 112, scenarios database 113, and an attack techniques database 114. Note that databases 105, 106, and 108-114 are shown as separate entities in FIG. 1. However, these databases 105, 106, and 108-114 may be contained on a single server, e.g., the LMS computing device 104. Alternatively, the databases 105, 105, 108-114 may be spread across several different servers (not shown).

The CATI computing device 103 and the LMS computing device 104 work together to perform several tasks. First, the CATI course computing device 103 determines a user's suitability for a career in cybersecurity, a learning style specific to the user, and specific careers suited for the user based upon answers provided by the user in the personality test. This information is provided to the LMS computing device 104.

Secondly, the LMS computing device 104 provides a learning environment designed to prepare the user for his/her cybersecurity work role using adaptive techniques based on information provided by the CATI course computing device 103 to the LMS computing device 104.

In this regard, one aspect of the cybersecurity system for career selection and adaptive learning 100 is an assessment method performed by the CATI computing device 103 to determine a user's natural preference for a career in cybersecurity. In one embodiment, the cybersecurity system for career selection and adaptive learning 100 comprises a cybersecurity selection system that includes a core set of personality questions, algorithms, methods, and Application Program Interfaces (APIs) to allow users to answer questions related to their behavioral preferences. In one embodiment, the cybersecurity system for career selection and adaptive learning 100 is configured to manage different sources of personality test values used to derive a user's information gathering, processing and decision-making tendencies. The cybersecurity system for career selection and adaptive learning 100 produces a plurality of instructional guidelines and career recommendations based on the personality test and the CATI algorithm that determines learning style and specific jobs/work roles suitable for the user.

In one embodiment, the cybersecurity system for career selection and adaptive learning 100 includes a core set of databases 105, 106, and 108-115, tools and application program interfaces (APIs) used to provide a plurality of learning methods to deliver a plurality of cyber education activities.

In one embodiment, the learning takes place within an immersive environment combining cybersecurity learning material and activities that are customized and adaptive to the users learning style by the LMS computing device 104. The game-like environment provides dynamic and highly interactive learning activities using the instructional guidelines and career recommendations from the results of the personality test and the CATI algorithm executed by the CATI computing device 103 and provided to the LMS computing device 104.

The LMS computing device 104 further comprises adaptive logic (not shown) that selects learning tools, activities, etc., based on derived user preferences and previous selections by the user. The LMS computing device 104 provides a realistic learning environment for cybersecurity to provide the necessary conditions for tasks along with a set standards related to the work role.

The LMS computing device 104 further implements offensive and defensive cybersecurity work roles and knowledge, skills, and aptitudes. Also, the LMS computing device 104 senses and adapts to the user's actions in the learning environment. Also, the LMS computing device 104 provides technical performance assessments leading to scoring to measure a user's progress and knowledge level. The LMS computing device 104 also offers awards to encourage and reward actions in the learning environment.

Initially, the cyber aptitude typology indicator (CATI) course is administered to a potential cybersecurity user. The CATI course involves the following modules:

1. History & Timeline of the Evolution of Cybersecurity;

2. Cyber Aptitude

3. Careers in Cybersecurity;

4. CATI test; and

5. Independent Research (career exploration)

The CATI course is designed to educate and test users who are interested in a career in cybersecurity. The CATI test is a personality test, for example, the Myers Briggs Type Indicator (MBTI), which is an extension of Carl Jung's theory of psychological typing. The MBTI has four personality dichotomies that combine to yield 16 personality types. The dichotomies are:

Introversion (I) vs. Extroversion (E) signifies the source and direction of a user's energy. It is sometimes described as a user's preferred orientation for information gathering, either inside themselves or to the outside world. The introvert's main interests are in the inner world of concepts and ideas, while the extravert is more involved with the outer world of people and things.

Sensing (S) vs. Intuition (N) represents the method by which someone perceives information. Sensing means that a user mainly believes information they receive directly from the external world. Intuition means that a user mainly believes information they receive from the internal world. Sensing is the use of the five physical senses to gather and evaluate facts, whereas the intuitive function integrates facts with memory and experience to enable a user to see possible applications for those facts. Sensing people pay attention to the five senses while intuitive people pay attention to possibilities.

Thinking (T)-Feeling (F) represents how a user processes information. Thinking means that a user decides mainly through analysis and logic. Feeling means that, as a rule, they decide based what they feel they should do (i.e., emotion).

Judging (J)-Perceiving (P) reflects how a user implements the information he or she has processed. Judging means that a user organizes all his life events and, as a rule, sticks to his plans. Perceiving means that the user is inclined to improvise and explore alternative options. This dichotomy was added by Myers and Briggs to dominant behavior between the second and third pair of functions. Individuals who prefer a structured lifestyle (J) are supposed to use their (thinking or feeling) functions while individuals who prefer a flexible lifestyle (P) are supposed to prefer the (sensing or intuition functions).

General conclusions on information gathering, processing and decision making as applied to the Cybersecurity skill set and job work roles are as follows: Cyber Analyst—High N (internal information) and high NT (analytical) is desirable; Cyber All—Both E and I (action minded or thought minded, breadth and depth); IT/Engineering—High ST (accepting information, policies and using them); Cyber Harden, Planning and Red Teaming—High J; Cyber Hunt/Pursue—High N (gather information) and a P (explores, improvises).

Therefore, the CATI computing device 103 administers the MBTI to a user who is interested in a career in cybersecurity. The MBTI is typically a 64-question analysis. In this regard, the MBTI may inquire: “You are always looking for opportunities,” “As a rule, current preoccupations worry you more than your future plans,” “It is easy for you to communicate in social situations,” “You rarely deviate from your habits,” “You willingly involve yourself in matters which engage your sympathies,” or “You easily perceive various ways in which events could develop.” These are merely exemplary questions.

The CATI computing device 103, employing the CATI algorithm (not shown) and using the MBTI results, determines if the user is suited for a cybersecurity career. In addition, the CATI course computing device 103 determines the types of jobs/work roles suited to the user in the field of cybersecurity based on the results of the personality test and the CATI algorithm.

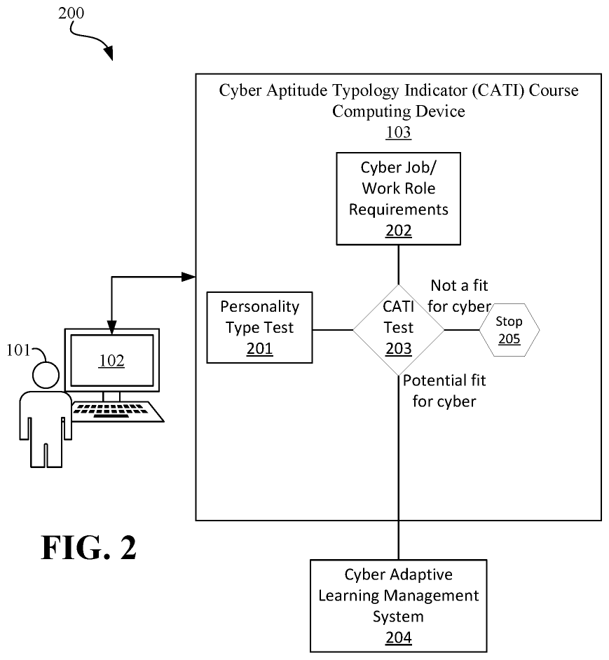

FIG. 2 is a block diagram that illustrates the processing performed by the CATI computing device 103. The user 101 accesses the CATI computing device 103 via the terminal 102.

The CATI course computing device 103 administers the personality type test 201. That is, the user answers 64 questions designed to determine the user's personality type. A CATI algorithm is employed to match the personality test results with cyber job/work role requirements 202. If the user is not fit for a cybersecurity role, the CATI computing device stops at 205. However, if the results of the personality test indicate that the individual is suited for a job in cybersecurity, data collected and results from the personality test and the CATI algorithm are transmitted to the LMS 104.

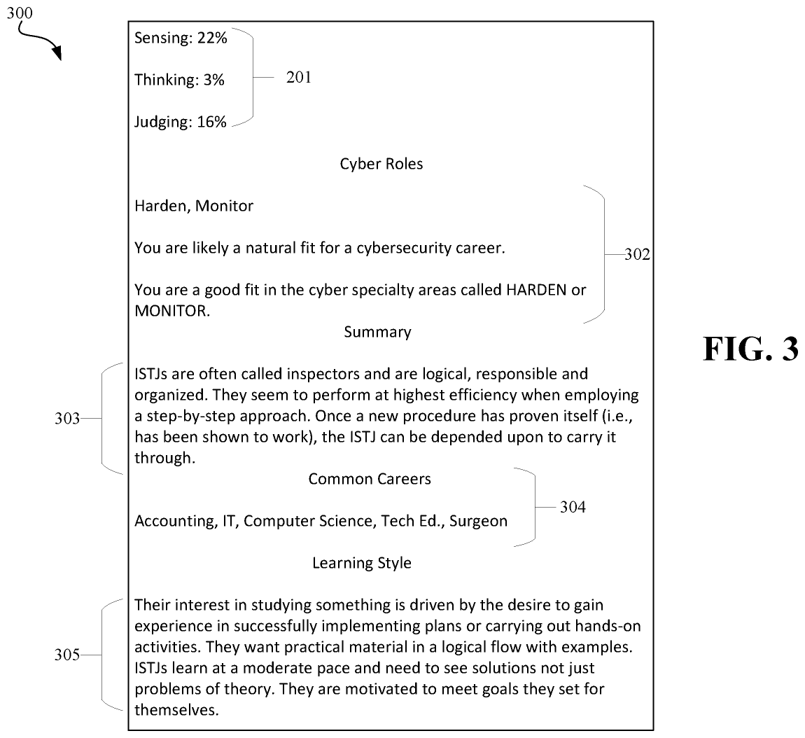

FIG. 3 is a graphical user interface (GUI) 300 that is displayed to the user tested once the CATI algorithm determines the relevant information. In this regard, the GUI indicates the personality traits and percentages, i.e., sensing: 22%; thinking: 3%; and judging: 16%.

The CATI algorithm compares these personality traits with different cybersecurity job/work role requirements. The CATI algorithm determines, based on the MBTI values and the cybersecurity job/work role requirements which cyber role is suited to the user. Also, the CATI algorithm determines one or more sub-disciplines appropriate for the user including harden, monitor, pursue, or coordinate.

Thus, the GUI 300 displays “Harden” and “Monitor.” These sub-disciplines are assigned the user based upon the personality test and the CATI algorithm. The GUI relates to the user that he/she is “likely a natural fit for a cybersecurity career,” and he/she is “a good fit in the cyber specialty areas called HARDEN or MONITOR,” described further herein.

In Summary, the GUI displays “ISTJs are often called inspectors and are logical, responsible and organized. They seem to perform at highest efficiency when employing a step-by-step approach. Once a new procedure has proven itself (i.e., has been shown to work), the ISTJ can be depended upon to carry it through.” An under “Common Careers,” the GUI displays Accounting, IT, Computer Science, Tech Ed., Surgeon.

Also displayed to the user is his/her learning style. The GUI 300 displays “Their interest in studying something is driven by the desire to gain experience in successfully implementing plans or carrying out hands-on activities. They want practical material in a logical flow with examples. ISTJs learn at a moderate pace and need to see solutions not just problems of theory. They are motivated to meet goals they set for themselves.”

Data indicative of the GUI information is transmitted to the LMS computing device 104 (FIG. 1). The LMS computing device 104 provides exercises and training selected to correlate to the cyber job/work role requirements 202 (FIG. 2) determined by the CATI algorithm and based upon the MBTI discovered during the personality type test 201 (FIG. 2).

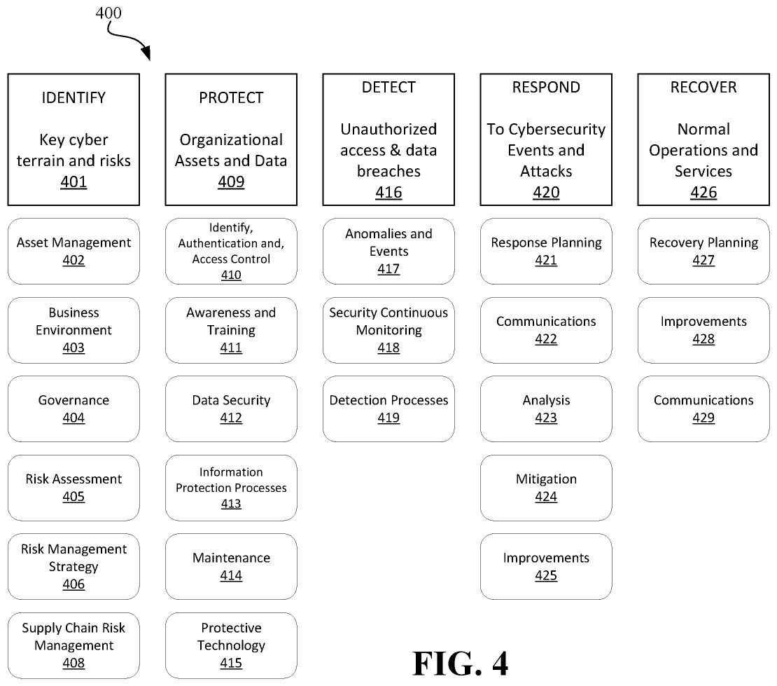

FIG. 4 is the National Institute of Standards and Technology (NIST) Cybersecurity Framework (NIST CSF). In this regard, the NIST CSF defines the breadth of cybersecurity skills that professionals seek in a cybersecurity education or training environment.

The NIST CSF comprises five (5) functions to achieve specific cybersecurity outcomes and references examples of guidance to achieve those outcomes. The NIST CSF is not a checklist of actions to perform. It presents key cybersecurity outcomes identified by stakeholders as helpful in managing cybersecurity risk. Notably, the NIST CSF chart 400 comprises the functions “Identify,” 401 “Protect,” 409 “Detect,” 416 “Respond,” 420 and “Recover” 426.

Each of these functions are associated with goals in the chart 400. “Identify” is associated with key cyber terrain and risks 401. “Protect” is associated with organizational assets and data 409, “Detect” is associated with Unauthorized access & data breaches 416, and “Respond” is associated with to cybersecurity events and attacks. “Recover” is associated with normal operations and services 426.

For each function, there is an associated list of tasks. “Identify” encompasses the tasks including asset management 402, business environment 403, governance 404, risk assessment 405, risk management strategy 406, and supply chain risk management 408. Thus, the corresponding tasks support the function “Identify.”

“Protect” encompasses the tasks including identify, authentication, and access control 410, awareness and training 411, data security 412, information protection processes 413, maintenance 414, and protective technology 415. Thus, the corresponding tasks support the function “Protect.”

“Detect” encompasses the tasks including anomalies and events 417, security continuous monitoring 418, and detection processes 419. Thus, the corresponding tasks support the function “Detect.”

“Respond” encompasses the tasks including response planning 421, communications 422, analysis 423, mitigation 424, and improvements 425. Thus, the corresponding tasks support the function “Respond.”

“Recover” encompasses the tasks including recovery planning 427, Improvements 428, and communications 429. Thus, the corresponding tasks support the function “Recover”.

A separate related standard for teaching cybersecurity is provided by the National Security Agency (NSA) as a designation of Center for Academic Excellence—Cyber Defense Education (CAE-CDE). The NSA CAE-CDE requirement for 2020 identities 69 Knowledge Units (KUs) (not Shown) and breaks them into foundational, technical, and non-technical core units and. optional knowledge units (KUs) (requiring a subset of optional KUs in the curriculum for an academic institution to be accredited).

Each KU contains learning outcomes and hands-on lab requirements that can be used to create courses in cybersecurity. All professionals in cybersecurity must understand cybersecurity foundations and principles along with basic information technology (IT) system components. The core KUs (both technical and non-technical) can be allocated to courses of various disciplines that can be mapped to the National Institute for Cybersecurity Education (NICE.) work roles.

The cybersecurity system for career selection and adaptive learning 100 of the present disclosure melds the NIST CSF best practices and the NSA Knowledge Units together to create a broad identification and learning tool. In this regard, the cybersecurity system for career selection and adaptive learning 100 of the present disclosure uses four main cyber sub-disciplines as technical areas of concentration to develop the cybersecurity selection and adaptive learning methods.

The four sub-disciplines are monitor, harden, pursue, and coordinate. The four sub-disciplines represent the entirety of KSAs, and tasks required to meet the best practices defined in the NIST CSF.

In this regard, each sub-discipline is associated with a series of actions that are necessary to fulfill the functions identify, protect, detect, respond, and recover.

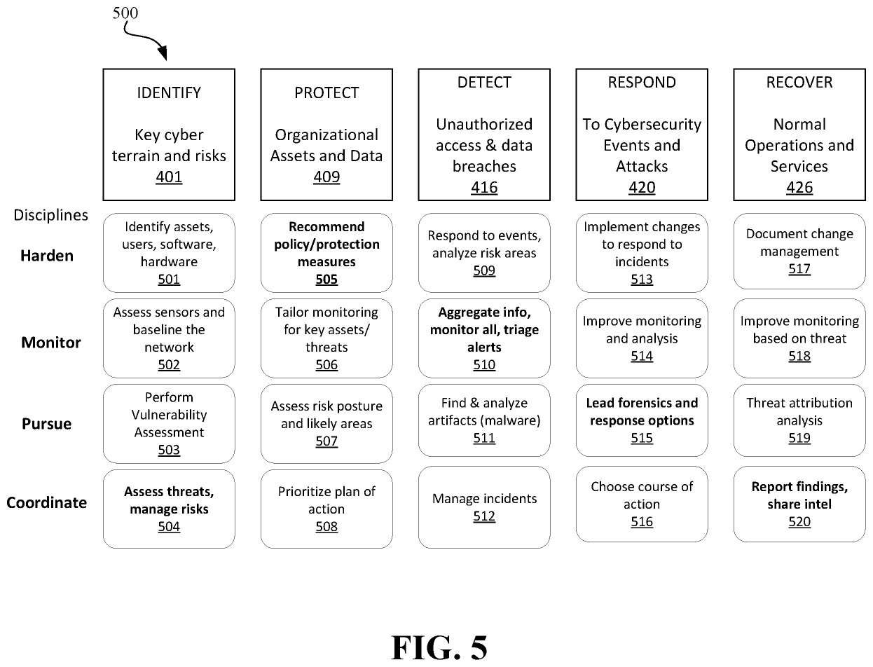

FIG. 5 is a chart 500 showing the sub-disciplines in conjunction with the NIST CSF functions and actions. The functions remain “Identify” 401, “Protect” 409, “Detect” 416, “Respond” 420, and “Recover 426.” Further, all the actions are present.

For “Identify”, the subdisciplines include identify assets, users, software, hardware 501, assess sensors and baseline the network 502, perform Vulnerability Assessment 503, and_assess threats, manage risks 504. Note that all the sub-disciplines are present, but one is bolded indicating it is the dominant sub-discipline.

For “Protect”, the subdisciplines include recommend policy/protection measure 505, Tailor monitoring for key assets/threats 506, Assess risk posture and likely areas 507, and prioritize a plan of action 508. Note that all the sub-disciplines are present, but one is bolded indicating it is the dominant sub-discipline.

For “Detect”, the sub-disciplines include respond to events and analyze risk areas 509, aggregate information, monitor all, and triage alerts 510, find and analyze artifacts (malware) 511, and manage incidents 512. Note that all the sub-disciplines are present, but one is bolded indicating it is the dominant sub-discipline.

For “Respond”, the sub-disciplines include implement changes to respond to incidents 513, improve monitoring and analysis 514, lead forensics and response options 515, and choose course of action 516. Note that all the sub-disciplines are present, but one is bolded indicating it is the dominant sub-discipline.

For “Recover”, the sub-disciplines include document change management 517, improve monitoring based on threat 518, threat attribution analysis 519, and report findings and share intel 520. Note that all the sub-disciplines are present, but one is bolded indicating it is the dominant sub-discipline.

The sub-disciplines of the present disclosure include “Harden,” “Monitor,” “Pursue,” and “Coordinate.” Courses provided to the LMS computing device 104 (FIG. 1) and to users-in-training are aligned to the sub-disciplines and are used to determine how a user's information processing tendencies fit within specific work roles for career selection.

For a particular educational cybersecurity discipline (i.e., harden, monitor, pursue, and coordinate), the LMS computing device 104 aligns specific courses with NICE work roles. The adaptive learning environment of the LMS 102 uses the MBTI type selector and algorithm of dichotomies to develop the best learning styles and activities for each sub-discipline for each user.

For example, for the “Harden” discipline, the key courses to address the scope of the NIST CSF include Core (cybersecurity, Windows, Linux, network fundamentals, offensive tactics), PowerShell scripting, reconnaissance, active directory, firewalls, secure mail, and Web. The corresponding NICE work role (job description) is CD infrastructure support specialist, security control assessor, security architect, and vulnerability assessment analyst.

As another example, for the “Monitor” discipline, the key courses to address the scope of the NIST CSF include Core (cybersecurity, Windows, Linux, network fundamentals, offensive tactics), Python scripting, packet analysis, intrusion detection, and network security monitoring. The corresponding NICE work role (job description) is cyber defense analyst, CD incident responder, software developer, and security architect.

For the “Pursue” discipline, the key courses to address the scope of the NIST CSF include Core (cybersecurity, Windows, Linux, network fundamentals, offensive tactics), PowerShell scripting, vulnerability analysis, reconnaissance, hunt, risk assessment, and forensics. The corresponding NICE work role (job description) is vulnerability assessment analyst, CD forensic analyst, secure software assessor, mission assessment analyst, and target network analyst counter intel/LE analyst.

For the “Coordinate” discipline, the key courses to address the scope of the NIST CSF include Core (cybersecurity, Windows, Linux, network fundamentals, offensive tactics), key terrain, risk management, incident response, legal/policy, and threat and intel analysis. The corresponding NICE work role (job description) is CD incident responder, counter intel/LE analyst, all source analyst, threat warning analyst, and cyber defense analyst.

The LMS computing device 104 provides learning pathways for six core courses in academia that cover the three core NSA KUs. The core and optional NSA KUs are mapped to the NIST CSF to develop the cyber sub-discipline or academic track leading to NICE work roles.

To complete a learning pathway that is customized to each user in cybersecurity, the LMS computing device 104 uses the MBTI and dichotomy values to determine specific activities for the learning environment based on the derived learning style.

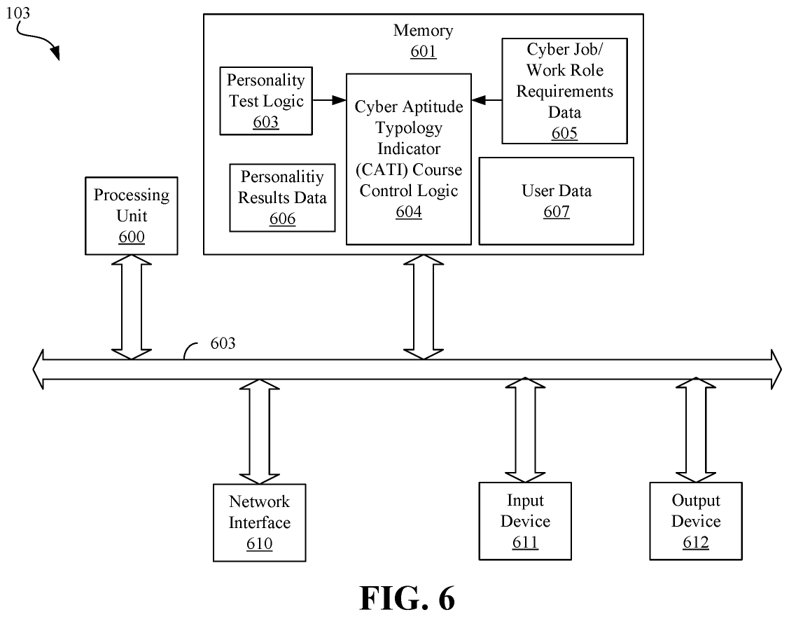

FIG. 6 is a block diagram of an exemplary embodiment of a cyber aptitude typology indicator (CATI) course computing device 103. The CATI course computing device 103 comprises a processing unit 600, a network interface 610, and an input device 611. Further, the CATI course computing device 103 comprises memory 601. Stored in memory 601 is a cyber aptitude typology indicator (CATI) control logic 604. The CATI control logic 604 may be software, hardware, firmware, or any combination thereof. The memory 601 further comprises personality test logic 603 and cyber job/work role requirements data 605. Stored in memory 601 is personality results data 606 and user data related to cybersecurity job/role 607.

The exemplary embodiment of the CATI course computing device depicted by FIG. 6 comprises the at least one conventional processing unit 600, such as a Digital Signal Processor (DSP) or a Central Processing Unit (CPU), that communicates to and drives the other elements within the CATI course computing device 103 via a local interface 603, which can include at least one bus. Further, the processing unit 600 is configured to execute instructions of software, such as the personality test logic 603 and the CATI control logic 604.

It should be noted that the CATI control logic 604 and the personality test logic 603 can be implemented in software, hardware, firmware, or any combination thereof. In an exemplary embodiment illustrated in FIG. 6, the CATI control logic 604 and the personality test logic 603 are implemented in software and stored in memory 601.

Note that the CATI control logic 604 and the personality test logic 603, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

An input device 611, for example, a keyboard, keypad, or mouse, can be used to input data from a user using the CATI course computing device 103, and an output device 612, for example, a printer or display screen (e.g., a Liquid Crystal Display (LCD)), can be used to output data to the user.

In addition, a network interface 610, such as a Network Interface Card (NIC), enables the CATI course computing device 103 to communicate via a network with the LMS computing device 64. Note that in other embodiments, the CATI course computing device 63 may wired directly to the LMS computing device 64, and a network may not be needed.

In operation, the CATI course computing device 103 communicates via the input device 611 with a user. The CATI control logic 604 receives user login information (not shown) and executes the personality test logic 603. The personality test logic 603 queries the user on a plurality of statement and/or questions. As described above, the personality test logic 603 may be implemented using the MBTI that uses sixty-nine questions to obtain data indicative of the user's personality and learning type.

Once the personality test logic 603 is completed, the personality test logic 603 stores the results in memory 601 as personality results data 606. The CATI course control logic 604 selects from the cyber job/work role requirements data one or more jobs/work roles that are suited for the user based upon the personality results data 606 and the CATI algorithm and stores the results as user data related to cybersecurity job/role 607. Further, the CATI course control logic 604 automatically transmits, or transmits upon demand, the data indicative of the personality type, the learning style, and the cybersecurity job/role 607 to the learning management system (LMS) computing device 104 via the network interface 610 or via a wired connection to the LMS computing device 104.

Regarding the user data 607, this data 607 comprises data indicative of the jobs/work roles suitable for the user based upon the personality results data 606. It further comprises data indicative of the user's learning style. Furthermore, the data may comprise data indicative of the user-selected behavior preference selections (FIG. 6-FIG. 9). This data 607 is transmitted to the LMS computing device 104 and is used by the LMS computing device 104 to teach and train the user.

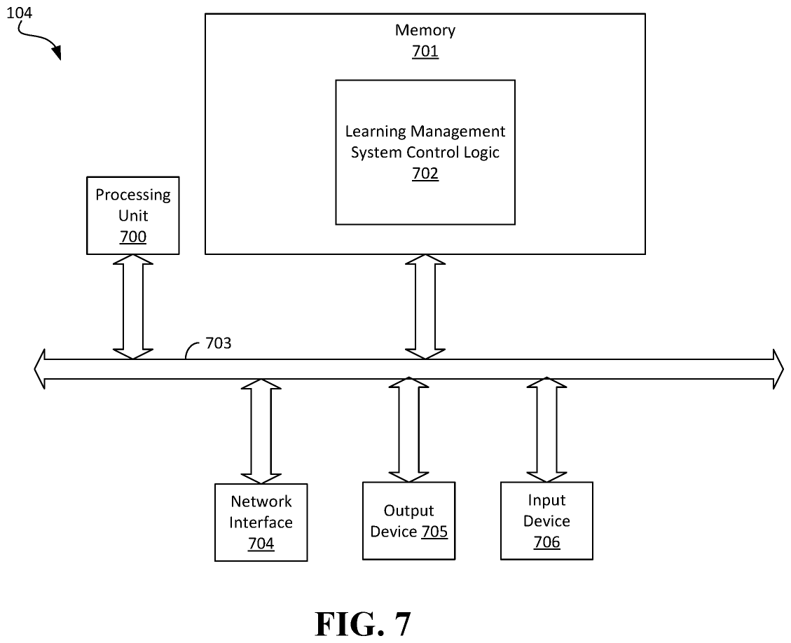

FIG. 7 is a block diagram of an exemplary embodiment of a learning management system (LMS) computing device 104. The LMS computing device 104 comprises a processing unit 700, a network interface 704, an input device 706, and an output device 705. Further, the LMS computing device 104 comprises memory 701. Stored in memory 701 is learning management system (LMS) control logic 702. The LMS control logic 702 may be software, hardware, firmware, or any combination thereof.

The exemplary embodiment of the LMS computing device 104 depicted by FIG. 7 comprises the at least one conventional processing unit 700, such as a Digital Signal Processor (DSP) or a Central Processing Unit (CPU), that communicates to and drives the other elements within the LMS computing device 104 via a local interface 703, which can include at least one bus. Further, the processing unit 700 is configured to execute instructions of software, such as the learning management system (LMS) control logic 702.

It should be noted that the LMS control logic 702 can be implemented in software, hardware, firmware, or any combination thereof. In an exemplary embodiment illustrated in FIG. 7, the LMS control logic 702 is implemented in software and stored in memory 1001.

Note that the LMS control logic 702, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

An input device 706, for example, a keyboard, keypad, or mouse, can be used to input data from a user using the LMS computing device 104, and an output device 705, for example, a printer or display screen (e.g., a Liquid Crystal Display (LCD)), can be used to output data to the user.

In addition, a network interface 704, such as a Network Interface Card (NIC), enables the LMS computing device 104 to communicate via a network with the CATI computing device 103. Note that in other embodiments, the LMS computing device 104 may wired directly to the CATI computing device 103, and a network may not be needed.

Furthermore, via the network interface 704, the LMS computing device 104 can communicate with the various data sources on the network. In this regard, the LMS computing device 104 can obtain the topics, knowledge, skills, and aptitude data 105 (FIG. 1), the competency areas and skills data 106 (FIG. 1), and the National Institute for Cybersecurity Education's Cybersecurity Workforce Framework data 107.

Additionally, as a user is training on an area identified by the CATI course, including the personality results data 1006 and the user data related to cybersecurity job/role 1007, the LMS computing device 104 can access data relevant to the user's personality data 1006 and the user data related to cybersecurity job/role 1007 from the knowledge databases, including concept module data 109 and questions to test knowledge 110. Further, the LMS computing device 104 can access skill databases, including activities data 108 through technical games 111, labs 112, and scenarios 113. Note that the scenarios data 113 may access the attack techniques data 114 to generate scenarios to present to the user.

Note that knowledge and skills tests presented to the user are customized. They are customized based upon the user data 607 (FIG. 6).

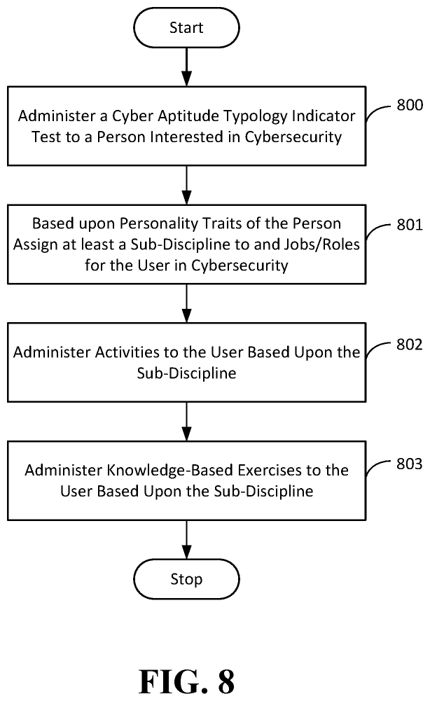

FIG. 8 is a flowchart depicting exemplary architecture and functionality of the cybersecurity system for career selection and adaptive learning 100 (FIG. 1).

In step 800, the cyber aptitude typology indicator (CATI) course control logic 604 (FIG. 6) administers a personality test to a user. In this regard, the CATI course control logic 604 presents a plurality of questions to the user and stores the responses to the test as personality results data 606 (FIG. 6). The personality test can be based on Myers Briggs Type Indicator (MBTI), which is an extension of Carl Jung's theory of psychological typing.

With these results, the CATI course control logic 604 assigns a sub-discipline and jobs/roles in cybersecurity based upon based upon the personality traits of the user discovered in step 801. The sub-disciplines can include harden, monitor, pursue, or coordinate. The sub-disciplines are based upon the National Institute of Standards and Technology Cybersecurity Framework (NIST CSF) and the National Security Association (NSA) Knowledge Units for CAE and CDE accreditation. Note that all the sub-disciplines are present in the functions of the NIST CSF; although one is more dominant.

In step 802, the learning management system (LMS) control logic 702 (FIG. 7) administers activities from activities data 108 (FIG. 1). The activities data 108 can comprise technical games found in technical games data 111 (FIG. 1), labs found in labs data 112 (FIG. 1), and scenarios found in scenario data 112 (FIG. 1). Each of the skills exercises, technical games, labs, and scenarios are designed to be provided to the user based upon his/her MBTI results, learning styles, and determined job/work roles.

In step 803, the learning management system (LMS) control logic 1102 administers knowledge activities to the user based upon the sub-discipline identified in step 801. For example, based upon a concepts modules data 109 (FIG. 1), the LMS control logic 1102 may administer questions to test the knowledge of the user based on data in the questions to test knowledge data 110 (FIG. 1). The questions are selected based upon the user's personality test, learning style, and determined job/work role.

1. A system for identifying a career suitable for a user in cybersecurity and providing an adaptive learning environment to the user's learning styles, comprising:
an input device;
an output device;
a processor configured for administering a personality test to the user by displaying questions on the output device and receiving responses to the questions from the user on the input device, the processor further configured to analyze the responses and assigning a suitable job/work role fit for the user in cybersecurity, the processor further configured to determine the user's learning style based upon the responses, the processor further configured to teach and/or train the user for the suitable job/work role based upon the user's responses and the user's learning style.

2. The system of claim 1, wherein the personality test is based upon a Myers Briggs Type Indicator (MBTI), which is an extension of Carl Jung's theory of psychological typing.

3. The system of claim 1, wherein the analyzing the responses and determining a suitable job/work role fit for the user in cybersecurity further comprises the processor configured for associating a sub-discipline to the user based upon the personality test and the job/work role assigned.

4. The system of claim 1, wherein the processor is communicatively coupled to at least one knowledge database and at least one skills database.

5. The system of claim 1, wherein the processor extracts knowledge data from the at least one knowledge database based upon the assigned job/work role and the determined learning style.

6. The system of claim 5, wherein the knowledge data comprises questions displayed to the user, the questions displayed related to the assigned job/work role and the determined learning style.

7. The system of claim 4, wherein the processor is further configured to extract skills data from the at least one skills database based upon the assigned job/work role and the determined learning style.

8. The system of claim 7, wherein the skills data extracted by the processor from the at least one skills database is data indicative of activities for the user to participate in, the activities selected based upon the assigned job/work role and the determined learning style.

9. The system of claim 8, wherein the activities data extracted by the processor comprise data indicative of technical games selected based upon the assigned job/work role and the determined learning style.

10. The system of claim 9, wherein the activities data extracted by the processor comprise data indicative of labs selected based upon the assigned job/work role and the determined learning style.

11. They system of claim 9, wherein the activities data extracted by the processor comprise data indicative of scenarios based upon the assigned job/work role and the determined learning style.

12. The system of claim 11, wherein the activities data extracted by the processor is attack technique data based upon the scenario data extracted and the assigned job/work role and the determine learning style.

13. A method for identifying a career suitable for a user in cybersecurity and providing an adaptive learning environment to the user's learning styles, comprising:
administering a personality test to the user by displaying questions on an output device;
receiving responses to the questions from the user on an input device;
analyzing the responses by a processor;
assigning, by a processor, a suitable job/work role fit for the user in cybersecurity based upon the responses;
determining, by the processor, the user's learning style based upon the responses;
electronically teaching and/or training the user for the suitable job/work role based upon the user's responses and the user's learning style.

14. The method of claim 13, further comprising administering the personality test based upon a Myers Briggs Type Indicator (MBTI), which is an extension of Carl Jung's theory of psychological typing.

15. The method of claim 13, further comprising analyzing, by the processor, the responses and determining a suitable job/work role fit for the user in cybersecurity and associating, by the processor, a sub-discipline to the user based upon the personality test and the job/work role assigned.

16. The method of claim 13, further comprising communicatively coupling to at least one knowledge database and at least one skills database.

17. The method of claim 16, further comprising extracting knowledge data from the at least one knowledge database based upon the assigned job/work role and the determined learning style.

18. The method of claim 17, further comprising displaying questions to the user based upon the knowledge data, the questions displayed related to the assigned job/work role and the determined learning style.

19. The method of claim 16, wherein the processor is further configured to extract skills data from the at least one skills database based upon the assigned job/work role and the determined learning style.

20. The system of claim 19, wherein the skills data extracted by the processor from the at least one skills database is data indicative of activities for the user to participate in, the activities selected based upon the assigned job/work role and the determined learning style.

21. The system of claim 20, wherein the activities data extracted by the processor comprise data indicative of technical games selected based upon the assigned job/work role and the determined learning style.

22. The system of claim 20, wherein the activities data extracted by the processor comprise data indicative of labs selected based upon the assigned job/work role and the determined learning style.

23. They system of claim 20, wherein the activities data extracted by the processor comprise data indicative of scenarios based upon the assigned job/work role and the determined learning style.

24. The system of claim 23, wherein the activities data extracted by the processor is attack technique data based upon the scenario data extracted and the assigned job/work role and the determine learning style.
